(19) United States
(12) Patent Application Publication
(10) Pub. No.: US 2019/0227956 A1
(43) Pub. Date: Jul. 25, 2019

(54) OUTPUT PROCESSING APPARATUS AND OUTPUT PROCESSING METHOD

(71) Applicant: DENSO TEN Limited, Kobe-shi, Hyogo (JP)

(72) Inventor: Naoto MATSUSHITA, Kobe-shi (JP)

(73) Assignee: DENSO TEN Limited, Kobe-shi, Hyogo (JP)

(21) Appl. No.: 16/332,970

(22) PCT Filed: Nov. 9, 2017
(86) PCT No.: PCT/JP2017/040501

§ 371 Date: Mar. 13, 2019

(30) Foreign Application Priority Data
Dec. 14, 2016 (JP) 2016-242281

(51) Int. Cl. G06F 13/12; G06F 3/14; G06F 3/16

(52) U.S. Cl. CPC G06F 13/122; G06F 3/167; G06F 3/1407

(57) ABSTRACT

An output processing apparatus according to one aspect of an embodiment includes an acquisition unit and an output processing unit. The acquisition unit acquires, from an external apparatus, extended application information. The extended application information includes (i) a display component that is used in operating an extended application included in the external apparatus and (ii) a descriptor that specifies a screen hierarchy of the display component. The output processing unit displays the display component in the screen hierarchy specified by the extended application information acquired by the acquisition unit.

### FIELD

The embodiment discussed herein is directed to an output processing apparatus and an output processing method.

### BACKGROUND

Conventionally, there has been known an output processing apparatus that outputs, to a display and/or a speaker, a result obtained by processing, in addition to a previously implemented application, an extended application of an external apparatus connected to the output processing apparatus (see Patent Literature 1, for example).

### CITATION LIST

### Patent Literature

Patent Literature 1: Japanese Laid-open Patent Publication No. 2014-038188

### SUMMARY

### Technical Problem

However, according to a conventional technology, software, which is fitted to an external apparatus to be connected, is to be previously implemented in an output processing apparatus side, and thus a design of the output processing apparatus is to be changed in accordance with an external apparatus having a connection possibility.

One aspect of the embodiment is made in view of the aforementioned, and an object of the embodiment is to provide an output processing apparatus and an output processing method, which is capable of improving the operability of a user without changing a design in accordance with an external apparatus.

### Solution to Problem

An output processing apparatus according to one aspect of an embodiment includes an acquisition unit and an output processing unit. The acquisition unit acquires, from an external apparatus, extended application information. The extended application information includes (i) a display component that is used in operating an extended application included in the external apparatus and (ii) a descriptor that specifies a screen hierarchy of the display component. The output processing unit displays the display component in the screen hierarchy specified by the extended application information acquired by the acquisition unit.

### Advantageous Effects of Invention

According to an aspect of the embodiment, it is possible to improve the operability of a user without changing a design in accordance with an external apparatus.

### BRIEF DESCRIPTION OF DRAWINGS

FIG. 1 is a diagram illustrating an outline of an output processing method.

FIG. 2 is a block diagram illustrating an output processing apparatus.

FIG. 3 is a diagram illustrating an outline of extended application information.

FIG. 4 is a diagram illustrating a specific example of adjustment information.

FIG. 5 is a diagram illustrating a specific example of an adjusting process to be executed by an adjusting unit.

FIG. 6 is a flowchart illustrating a procedure for an outputting process to be executed by the output processing apparatus.

FIG. 7 is a flowchart illustrating a procedure for the adjusting process to be executed by the output processing apparatus.

### DESCRIPTION OF EMBODIMENTS

Hereinafter, an embodiment of an output processing apparatus and an output processing method according to the present application will be described in detail with reference to the accompanying drawings. The present disclosure is not limited to the embodiment described in the following.

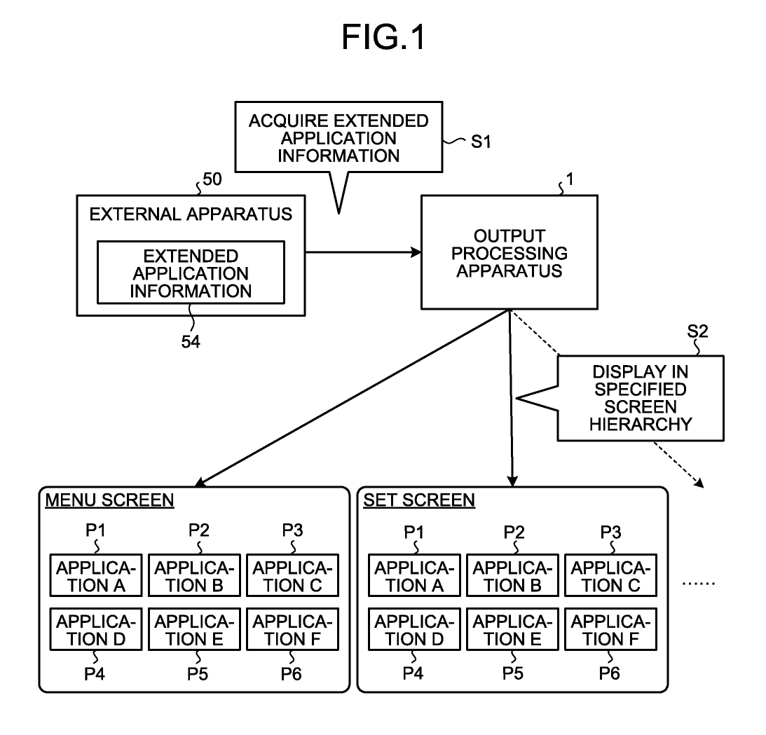

First, the output processing method according to the embodiment will be explained with reference to FIG. 1. FIG. 1 is a diagram illustrating an outline of the output processing method. An output processing apparatus 1 and an external apparatus 50, which are illustrated in FIG. 1, transmit and receive information therebetween to execute this output processing method.

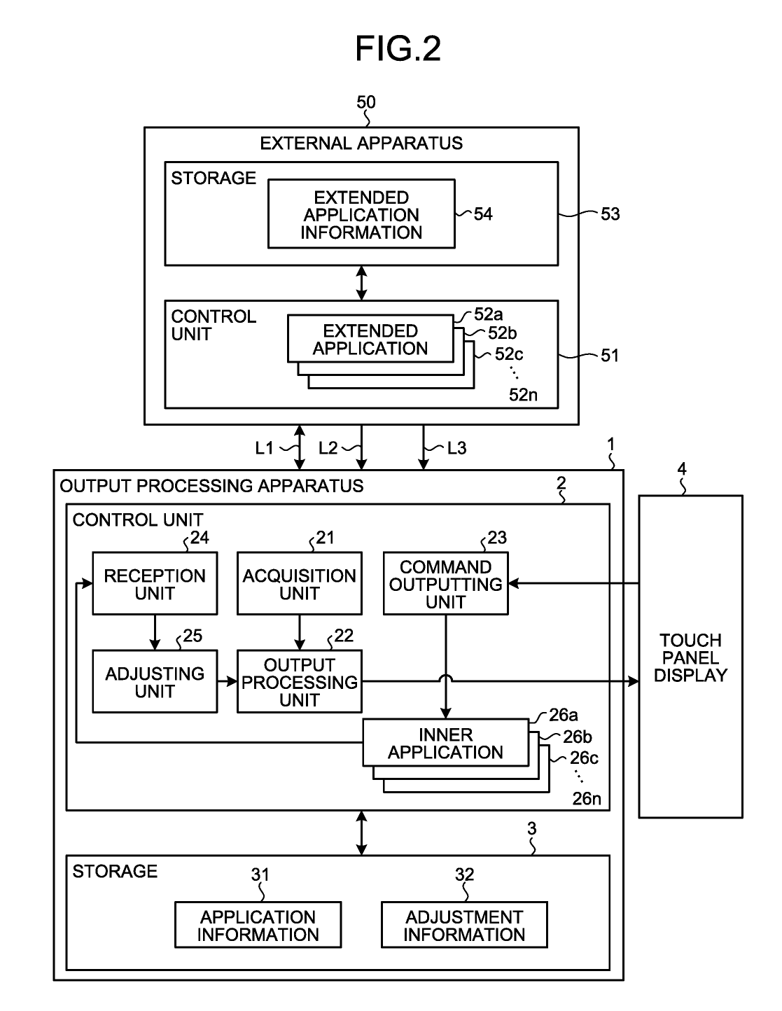

The output processing apparatus 1 is provided in a vehicle, for example, and is connected to the external apparatus 50 via a signal cable L1 (see FIG. 2). The output processing apparatus 1 outputs, to an output device such as a touch panel display, a processing result of an extended application that is executed by the external apparatus 50.

Herein, in a conventional output processing apparatus, software, which is according to an extended application of the external apparatus 50 to be connected, needs to be previously implemented in the output processing apparatus 1 side.

Specifically, in a case where this software is not implemented, the conventional output processing apparatus displays the same display component with respect to all of extended applications even when the extended applications are different from each other, for example.

Thus, a user is not able to distinguish a correspondence between a displayed component and a corresponding extended application in some cases, namely, there presents possibility that the operability of a user with respect to the external apparatus 50 may reduce.

Therefore, in the output processing method according to the embodiment, information corresponding to the above-mentioned software has been stored in the external apparatus 50 side. Specifically, as illustrated in FIG. 1, first, in the output processing method according to the embodiment, the output processing apparatus 1 acquires extended application information 54 from the external apparatus 50 (Step S1).

The extended application information 54 includes a display component P, which is for a user to operate an extended application to be executed by the external apparatus 50, and a descriptor that describes information on the display component P.

The display component P includes image data such as an operation button and an icon indicating an extended application, which are displayed on a touch panel display. The descriptor includes information that specifies a screen hierarchy of the display component P, for example.

The extended application information 54 is generated on the basis of a rule distributed from a manufacturer of the output processing apparatus 1 side to each manufacturer of the external apparatuses 50 side, for example.

Thus, when the output processing apparatus 1 interprets the extended application information 54 on the basis of this rule, it is possible to interpret the extended application information 54 regardless of the external apparatus 50 to be connected.

Subsequently, in the output processing method according to the embodiment, the output processing apparatus 1 displays the display component P in a screen hierarchy that is specified by the extended application information 54 (Step S2).

For example, when a screen hierarchy output from the output processing apparatus 1 is a menu screen, the display component P of an extended application, which is corresponding to the menu screen, is displayed. When the screen hierarchy is a set screen that is under the menu screen, the display component P of an extended application, which is corresponding to the set screen, is displayed.

Thus, it is possible to seamlessly display display components P1 to P3 of inner applications stored in the output processing apparatus 1 and display components P4 to P6 of extended applications.

Details will be mentioned later, in the output processing method according to the embodiment, when a user selects any of the display components P4 to P6, the output processing apparatus 1 may output a command corresponding to selected one of the display components P4 to P6 to the external apparatus 50.

Thus, the output processing apparatus 1 side is capable of controlling an extended application of the external apparatus 50 similarly to an inner application. In other words, in the output processing method according to the embodiment, it is possible to realize seamless cooperation between the output processing apparatus 1 and the external apparatus 50.

Therefore, by employing the output processing method according to the embodiment, it is possible to improve the operability of a user without changing a design of the output processing apparatus 1 in accordance with the external apparatus 50.

In the above-mentioned example, the case has been disclosed in which the output processing apparatus 1 is connected to the one external apparatus 50; however, the output processing apparatus 1 may be connected to the plurality of external apparatuses 50. Even in this case, the plurality of external apparatuses 50 is able to be controlled from the output processing apparatus 1 side.

In the above-mentioned example, the case has been disclosed in which the same display components P are displayed in both of the menu screen and the set screen; however, the different display component(s) P may be displayed in accordance with a displayed screen. Moreover, an arrangement of the display components P illustrated in FIG. 1 is merely one example, and not limited thereto.

Meanwhile, when there presents a plurality of pieces of information to be provided to a user, the output processing apparatus 1 is also capable of adjusting which piece of the information is to be preferentially output. Moreover, this adjustment does need any change in a design of the output processing apparatus 1 side. Details of this point will be disclosed below with reference to FIG. 5.

Hereinafter, applications A to C will be explained as inner applications of the output processing apparatus 1, and applications E to F will be explained as extended applications of the external apparatus 50.

Next, a configuration of the output processing apparatus 1 according to the embodiment will be explained with reference to FIG. 2. FIG. 2 is a block diagram illustrating the output processing apparatus 1. In FIG. 2, a touch panel display 4 is illustrated in addition to the output processing apparatus 1 and the external apparatus 50.

The touch panel display 4 includes a display, an operation unit, a sound outputting unit, and the like. The touch panel display 4 outputs an image output from the output processing apparatus 1, and/or a sound.

The touch panel display 4 detects a contact position of a user on the operation unit (for example, touch panel), and outputs an operation signal according to the contact position to the output processing apparatus 1, for example. The case is disclosed here in which the touch panel display 4 serves as the display, the operation unit, the sound outputting unit, etc.; however, the display, the operation unit, and the sound outputting unit may be separately arranged.

The external apparatus 50 includes a control unit 51 and a storage 53. The control unit 51 includes a plurality of extended applications 52a to 52n, for example. The extended applications 52a to 52n generate provision information to be provided to a user in accordance with an execution situation of each of the extended applications, and output the generated provision information to the output processing apparatus 1, for example.

These extended applications 52a to 52n include, for example, a navigation application, traffic-information receiving application, and the like. The navigation application generates provision information such as image data and sound data indicating a route to a destination.

The navigation application generates provision information indicating an advancing direction when a fork in a road is approaching on a route. The traffic-information receiving application receives traffic jam information and/or traffic accident information around a vehicle, and generates provision information on the basis of the received information.

The extended applications 52a to 52n output, to the output processing apparatus 1, an output request that includes the generated provision information and a parameter (hereinafter, may be referred to as “adjustment parameter”) indicating a priority in a provision order of this provision information to a user.

The adjustment parameter is previously allocated by a designer in accordance with a priority of provision information in designing the extended applications 52a to 52n, for example.

Hereinafter, the extended applications 52a to 52n may be collectively referred to as extended applications 52, and inner applications 26a to 26n to be mentioned later may be referred to as inner applications 26. The above-mentioned extended applications 52 are merely one example, and not limited thereto.

As described above, the output processing apparatus 1 is capable of seamlessly controlling the extended applications 52 and the inner applications 26 included in the output processing apparatus 1. Thus, hereinafter, when there presents no need for distinguishing between the inner application 26 and the extended application 52, they may be referred to as an “application” or “app”.

The storage 53 stores therein the extended application information 54. The extended application information 54 includes the display component P for operating the extended application 52 (see FIG. 1) and a descriptor for specifying a screen hierarchy of the display component P.

As illustrated in FIG. 2, the output processing apparatus 1 is connected with the external apparatus 50 via the signal cable L1, a video cable L2, and a sound cable L3. The signal cable L1 is a communication cable that is capable of transferring therethrough information in both directions.

The video cable L2 transfers therethrough image data (data of plurality of time-dependently continuous images) generated by the extended application 52 from the external apparatus 50 to the output processing apparatus 1.

The sound cable L3 transfers therethrough sound data generated by the extended application 52 from the external apparatus 50 to the output processing apparatus 1. Herein, the signal cable L1, the video cable L2, and the sound cable L3 are disclosed as separated cables; however, these cables may be provided as one cable.

The output processing apparatus 1 and the external apparatus 50 may exchange therebetween information by using wireless communication. Illustration of the aforementioned is omitted in FIG. 2; however, the same applies to connection between the output processing apparatus 1 and the touch panel display 4.

The output processing apparatus 1 includes a control unit 2 and a storage 3. The control unit 2 includes an acquisition unit 21, an output processing unit 22, a command outputting unit 23, a reception unit 24, an adjusting unit 25, and the inner application 26.

The storage 3 stores therein application information 31 and adjustment information 32. The application information 31 includes the above-mentioned extended application information 54 and information for controlling the inner application 26. The adjustment information 32 is information on an adjustment parameter with respect to presently-output provision information, and is updated by the adjusting unit 25.

The control unit 2 includes a computer including, for example, a Central Processing Unit (CPU), a Read Only Memory (ROM), a Random Access Memory (RAM), a Hard Disk Drive (HDD), and an input/output port; and various circuits.

For example, the CPU of the computer reads and executes a program stored in the ROM so as to function as the acquisition unit 21, the output processing unit 22, the command outputting unit 23, the reception unit 24, the adjusting unit 25, and the inner application 26 of the control unit 2.

Moreover, at least one or all of the acquisition unit 21, the output processing unit 22, the command outputting unit 23, the reception unit 24, the adjusting unit 25, and the inner application 26 of the control unit 2 may be constituted of hardware such as an Application Specific Integrated Circuit (ASIC) and/or a Field Programmable Gate Array (FPGA).

The storage 3 corresponds to an RAM and/or an HDD, for example. The RAM and/or the HDD are capable of storing therein the application information 31 and the adjustment information 32. The output processing apparatus 1 may acquire the above-mentioned program and various kinds of information via another computer or a portable recording medium connected by using a network in a wired or wireless manner.

For example, when the new external apparatus 50 is connected to the output processing apparatus 1 at a start-up of the output processing apparatus 1, the acquisition unit 21 of the control unit 2 acquires, from the external apparatus 50, the extended application information 54 via the signal cable L1. The acquisition unit 21 stores, in the storage 3 as the application information 31, the acquired extended application information 54.

As described above, the acquisition unit 21 stores, in the storage 3 that is on the output processing apparatus 1 side, the extended application information 54 to be able to reduce the number of acquisition times of the extended application information 54. Thus, it is possible to reduce processing load needed for acquiring the extended application information 54.

The acquisition unit 21 may sequentially acquire needed pieces of the extended application information 54 in accordance with hierarchies of screens that are output from the output processing unit 22 to the touch panel display 4.

In this case, all pieces of the extended application information 54 are not to be stored in the storage 3 on the output processing apparatus 1 side, and thus a storing medium having a small storing capacity, which is inexpensive, may be employed for the storage 3 of the output processing apparatus 1. Therefore, it is possible to reduce the cost of components of the output processing apparatus 1.

Assume that the application information 31 includes the extended application information 54 and information on the inner application 26 corresponding to the extended application information 54.

The output processing unit 22 displays the display component P in a screen hierarchy that is specified by the extended application information 54 acquired by the acquisition unit 21. Specifically, the output processing unit 22 generates, with reference to the application information 31, an image in which the display component P corresponding to a hierarchy of a screen to be output is displayed, and outputs the generated image to the touch panel display 4.

In this case, as a result of the reference to the application information 31, when there presents the plurality of display components P in a hierarchy of a screen whose output is desired, the output processing unit 22 generates an image that displays a list of the plurality of display components P.

Thus, on the touch panel display 4, the display components P of the extended applications 52 and the display components P (to be mentioned later) of the inner applications 26 are seamlessly displayed.

The output processing unit 22 generates information (hereinafter, may be referred to as “display position information”) on a display position of each of the display components P, and stores the generated information in the storage 3. The command outputting unit 23 recognizes the display position of each of the display components P on the basis of this display position information.

Meanwhile, for example, a conventional output processing apparatus displays the display components P of the inner applications 26 on a set screen; however, does not display thereon the display components P of the extended application 52.

Thus, when a user is going to change a setting of the extended application 52, he/she needs to call the extended application 52 from a menu screen and change the setting of the extended application 52, for example.

Thus, in the conventional output processing apparatus, when a user is going to change a setting of the extended application 52, he/she needs to go back and forth between screen hierarchies in order to change the setting, thereby leading to increase in an operation time interval. Therefore, in the conventional output processing apparatus, the operability of a user is reduced.

On the other hand, the output processing apparatus 1 according to the embodiment is capable of displaying, on a set screen, a list of the corresponding display components P regardless of whether the application is the inner application 26 or the extended application 52.

Therefore, a user is able to change a setting of each of the extended applications 52 with a few operations. Thus, it is possible to shorten an operation time interval to be able to improve the operability of a user.

When the command outputting unit 23 (to be mentioned later) outputs a command to an application, the output processing unit 22 gives, to this application, a privilege (hereinafter, may be referred to as “output privilege”) of outputting to the touch panel display 4.

Hereinafter, a case where the output processing unit 22 has an output privilege, namely, a case where a display screen displayed on the touch panel display 4 is a menu screen, a set screen, or the like is referred to as an inner output mode, and a case where an application has the output privilege is referred to as an external output mode.

When the display component P is selected, the command outputting unit 23 outputs a command, which is corresponding to the display component P, to the extended application 52 or the inner application 26.

Specifically, when an operation signal is input from the touch panel display 4, the command outputting unit 23 recognizes, on the basis of this operation signal and the above-mentioned display position information, which of the display components P the operation signal selects.

Subsequently, the command outputting unit 23 reads, from the application information 31 stored in the storage 3, a command corresponding to the selected display component P. The command outputting unit 23 converts the operation signal into this command, and outputs this command to a corresponding application.

Thus, the application is able to execute a control corresponding to this command. In other words, it is possible to control the extended application 52 from the output processing apparatus 1 side.

In a case of the above-mentioned external output mode, the touch panel display 4 displays an image that is output from an application having an output privilege.

Thus, in a case of the external output mode, when acquiring an operation signal from the touch panel display 4, the command outputting unit 23 outputs, to an application having an output privilege, an operation signal as it is. Next, the application analyzes this operation signal by itself so as to execute a control according to the operation signal.

In other words, in the external output mode, the command outputting unit 23 does not convert an operation signal into a command but outputs the operation signal as it is, so that each application is able to perform a control in accordance with an image drawn by itself.

Therefore, the application is able to execute a finer control (for example, detailed setting of application etc.) on other than the above-mentioned command. In this case, it is possible to omit a process of the command outputting unit 23 for converting an operation signal into a command, so that it is possible to reduce a processing load of the command outputting unit 23.

The reception unit 24 receives an output request that is input thereto from each application, and gives the received output request to the adjusting unit 25. When an output request is input from the reception unit 24, the adjusting unit 25 adjusts whether or not provision information from the output requesting side is output instead of provision information presently being output from the touch panel display 4. A specific example of the adjusting process to be executed by the adjusting unit 25 will be mentioned later with reference to FIG. 5.

A conventional output processing apparatus previously stores therein an adjustment table that prescribes priorities of pieces of provision information, and adjusts the provision information on the basis of this adjustment table.

When the external apparatus 50 or a new application is added, win-or-lose results of all of adjustments between already-existing provision information and newly-added provision information in this adjustment table are to be decided so as to make a change in accordance therewith.

On the other hand, the output processing apparatus 1 according to the embodiment acquires an adjustment parameter for each of the pieces of provision information as described above, so as to execute an adjustment on the basis of the acquired adjustment parameters. Thus, the output processing apparatus 1 according to the embodiment is capable of appropriately executing an adjustment without needing any adjustment table.

Therefore, it is possible to execute an adjustment without changing a design of the output processing apparatus 1 side, even when the new external apparatus 50 is connected to the output processing apparatus 1.

Similarly to the extended application 52, the inner applications 26a to 26n generate, in accordance with an execution situation of each application, provision information to be provided to a user; and outputs an output request to the reception unit 24. The inner applications 26a to 26n include, for example, an audio application that reproduces music and/or video, a television application that receives electrical waves of the television and outputs television images, and a fuel-consumption calculating application that calculates the fuel consumption of a vehicle. The inner applications 26a to 26n are not limited to the above-mentioned examples, and may be arbitrary changed.

The output processing apparatus 1 may have a configuration that does not include the inner application 26. In this case, it is possible to reduce the manufacturing cost of the output processing apparatus 1.

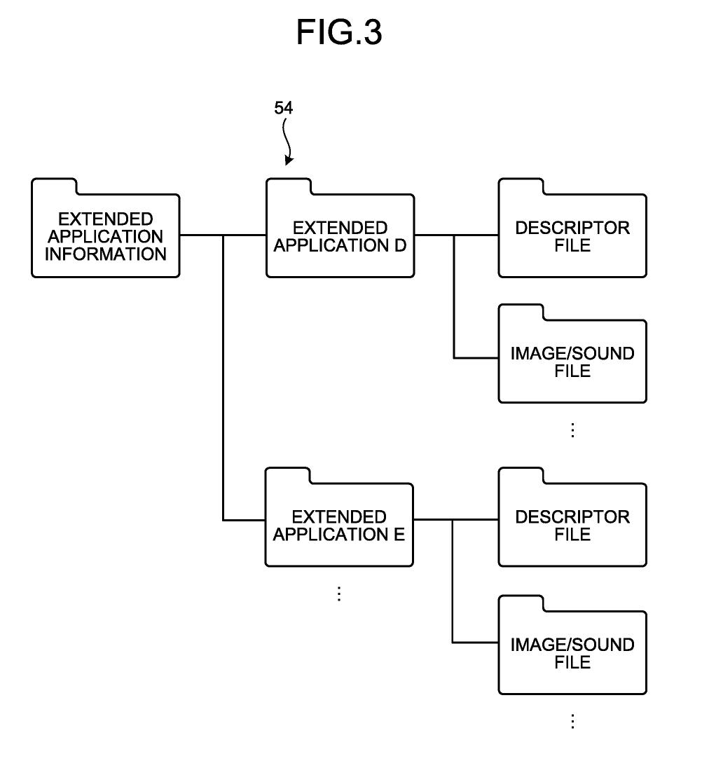

Next, the extended application information 54 will be explained with reference to FIG. 3. FIG. 3 is a schematic diagram illustrating the extended application information 54.

As illustrated in FIG. 3, a descriptor file and an image/sound file are stored, for each extended application, in the extended application information 54.

Specifically, the descriptor file stores therein a descriptor that describes information on the display component P. Information (hereinafter, may be described as “description information”) described by this descriptor includes a name of the display component P, information that specifies a screen hierarchy of the display component P, an address at which the display component P is stored, etc.

The description information includes a command that is output from the command outputting unit 23 when the display component P is selected as described above. Furthermore, the description information may include, for example, information for specifying sound data of an operation sound when the display component P is selected, and an address at which this sound data is stored.

In this case, when a user selects the display component P, the output processing unit 22 causes a sound outputting unit to output an operation sound corresponding to the selected display component P. Thus, the output processing apparatus 1 is capable of causing the user to recognize, in an auditory manner, that a selecting operation of the display component P is received.

In the present embodiment, formats of descriptors stored in all of the external apparatuses 50 are standardized. Thus, even when the new external apparatus 50 is connected, the output processing apparatus 1 is capable of similarly controlling the newly-added external apparatus 50.

The format of the descriptors has, for example, a form of Extensible Markup Language (XML); however, not limited thereto as long as the formats are standardized. Moreover, the number of formats of the descriptors may be one or more.

In an image/sound file, image data of the display component P, sound data of an operation sound to be output when this display component P is selected, etc. are stored at an address that is decided by a descriptor.

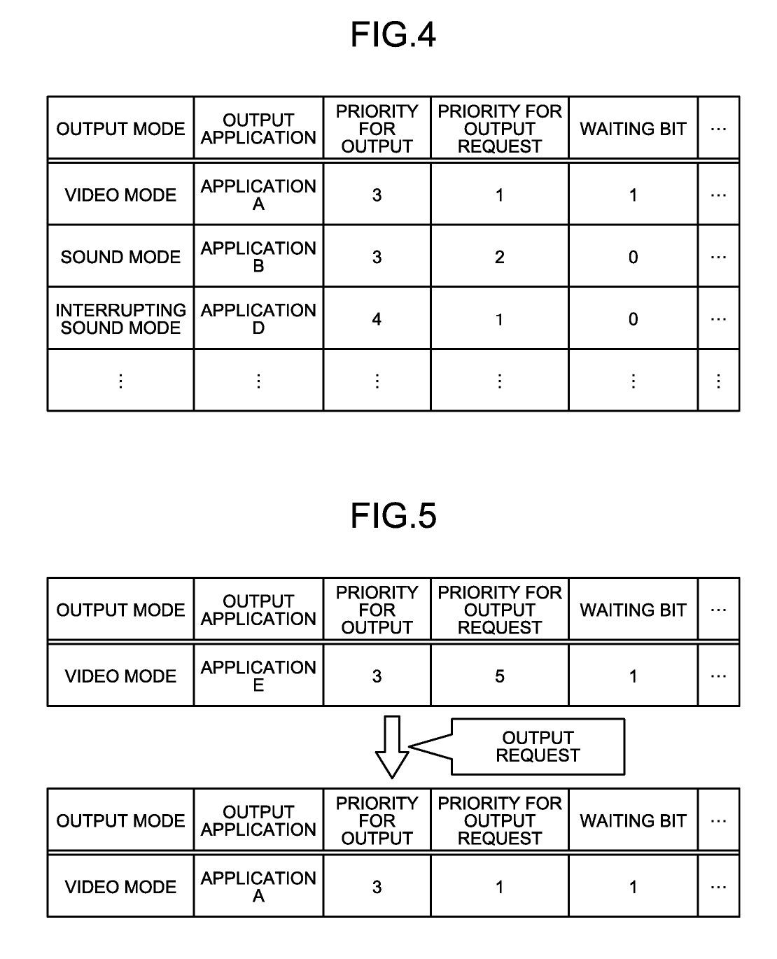

Next, the adjustment information 32 will be explained with reference to FIG. 4. FIG. 4 is a diagram illustrating a specific example of the adjustment information 32. The adjustment information 32 includes information on an adjustment parameter of provision information being presently output, and is updated as needed in accordance with an adjusted result of the adjusting unit 25.

An “output mode” illustrated in FIG. 4 indicates a type of content of provision information that is output from the touch panel display 4 (see FIG. 2). This output mode includes, in addition to a video mode and a sound mode, an interrupting sound mode that indicates an interruption of a sound, for example.

An “output application” illustrated in FIG. 4 indicates an application that is presently being output in each output mode. In the example illustrated in FIG. 4, it is indicated that provision information provided by the application A and the application B, which are the inner application 26, is presently being output in the video mode and the sound mode. It is indicated that provision information provided by an application D, which is the extended application 52, is presently being output in the interrupting sound mode.

As illustrated in FIG. 4, the output processing apparatus 1 according to the embodiment is configured to have a plurality of adjustment parameters each of which indicates an output priority of provision information output from a corresponding application.

Specifically, the adjustment parameter includes a “priority for output” and a “priority for output request”. This is because a priority for output request and a priority during an output are different from each other in some cases.

Hereinafter, assumed that a provision priority is higher as a numeric value of an adjustment parameter is larger. For example, provision information such as traffic jam information around a vehicle and peripheral traffic regulation information is to be reported comparatively early to a user in real time; however, after it has been output, the necessity for continuously outputting it is low.

Thus, to this provision information, a parameter is allocated so that a priority for output request is higher than a priority for output. In other words, to provision information to be provided in real time, a value is allocated to a parameter for output request, which is higher than a value to be allocated to a parameter for output.

As illustrated in FIG. 4, a “waiting bit” may be allocated, as an adjustment parameter, to each piece of provision information. This waiting bit indicates whether or not an output of provision information is suspended when being lost in an adjustment. For example, when a waiting bit is “1”, an output of provision information is suspended.

The suspended provision information is once stored in the storage 3, and is output after provision information that won the adjustment has been output. Thus, a plurality of pieces of provision information is able to be sequentially output in an order to be output. On the other hand, when a waiting bit is “0”, this provision information is not suspended, but its output is canceled.

Next, an adjusting process to be executed by the adjusting unit 25 will be explained with reference to FIG. 5. FIG. 5 is a diagram illustrating a specific example of the adjusting process to be executed by the adjusting unit 25. A case is disclosed as an example in which an output request is input from the application E that is the extended application 52 illustrated in FIG. 5.

As illustrated in FIG. 5, an output request includes an output mode and an adjustment parameter. When acquiring an output request, the adjusting unit 25 recognizes an output mode and a priority for output request that are included in the output request. In the example illustrated in FIG. 5, an output mode of the application E in an output request is a video mode.

Thus, the adjusting unit 25 compares a parameter of a priority for output of the application A, which is presently being output in a video mode, with a parameter of a priority for output request of the application E, which is included in the output request.

As a result of the comparison, the adjusting unit 25 determines that provision information having a parameter whose priority is higher wins the adjustment. In the example illustrated in FIG. 5, a priority for output of the application A that is presently being output is “3”, and a priority for output request of the application E is “5”.

Thus, the adjusting unit 25 determines that the provision information of the application E wins the adjustment, outputs this provision information to the output processing unit 22, and causes the touch panel display 4 (see FIG. 2) to output the output provision information.

As a result of the adjustment, the adjusting unit 25 checks a waiting bit of the lost application A. The waiting bit of the application A is here “1”, and thus the adjusting unit 25 suspends this provision information to output the provision information of the application A after an output of the provision information of the application E has ended.

The adjusting unit 25 updates the video mode of the adjustment information 32 illustrated in FIG. 4 from an adjustment parameter of the application A into an adjustment parameter of the application E. Thus, the adjustment parameter that is presently being output is stored in the adjustment information 32.

The case is here disclosed in which the adjusting unit 25 acquires, for each output request, an adjustment parameter from a corresponding application (herein, application E); however, not limited thereto.

For example, the output processing apparatus 1 may acquire from the external apparatus 50, when connected to the external apparatus 50, adjustment parameters with respect to all pieces of provision information as the above-mentioned extended application information 54, and may store the acquired adjustment parameters in the storage 3.

In this case, the adjusting unit 25 may call, from the storage 3, an adjustment parameter in accordance with provision information output from the extended application 52, so as to execute an adjustment.

Depending on provision information, as a result of an adjustment, there presents a case of a draw, namely, a case where parameters of both are equal to each other, in some cases. Thus, a sub-priority parameter may be further provided, for each piece of the provision information, in preparation for a case of a draw.

The adjusting unit 25 may further execute an adjustment by using the sub-priority parameters when the first adjustment results is a draw. Thus, it is possible to subdivide an adjusted result to execute a determination even in a case of pieces of provision information whose priorities compete with each other.

The adjustment with respect to a video mode is here disclosed as an example; however, the same is applied to other output modes (sound mode, interrupting sound mode, etc.). When simultaneously acquiring, from one application, output requests with respect to a plurality of output modes (for example, video mode, sound mode, etc.), the adjusting unit 25 may execute an adjustment for each output mode, for example.

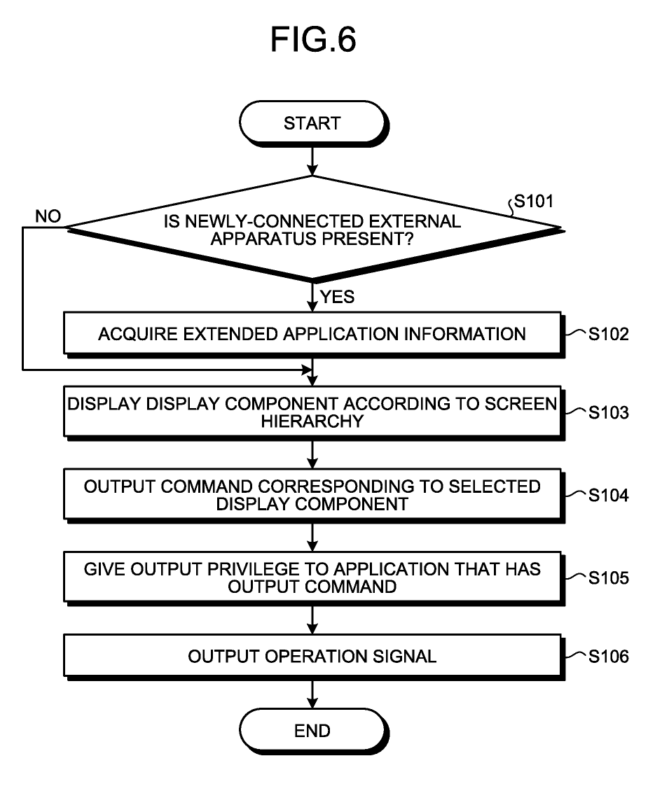

Next, a processing procedure to be executed by the output processing apparatus 1 according to the embodiment will be explained with reference to FIG. 6. FIG. 6 is a flowchart illustrating the processing procedure to be executed by the output processing apparatus 1.

As illustrated in FIG. 6, the acquisition unit 21 of the output processing apparatus 1 determines whether or not there presents the external apparatus 50 that is newly connected to the output processing apparatus 1 (Step S101). When the external apparatus 50 is newly connected to the output processing apparatus 1 (Step S101: Yes), the acquisition unit 21 acquires the extended application information 54 (Step S102).

On the other hand, when the new external apparatus 50 is not connected to the output processing apparatus 1 (Step S101: No), the extended application information 54 has already been acquired, and thus the control is shifted to Step S103 while omitting Step S102.

The output processing unit 22 causes the touch panel display 4 to display the display component P according to a screen hierarchy (Step S103). Next, when the display component P is selected, the command outputting unit 23 outputs a command that corresponds to the selected display component P (Step S104).

The output processing unit 22 gives, to the selected application, an output privilege (Step S105), the command outputting unit 23 outputs an operation signal (Step S106), and ends the processing.

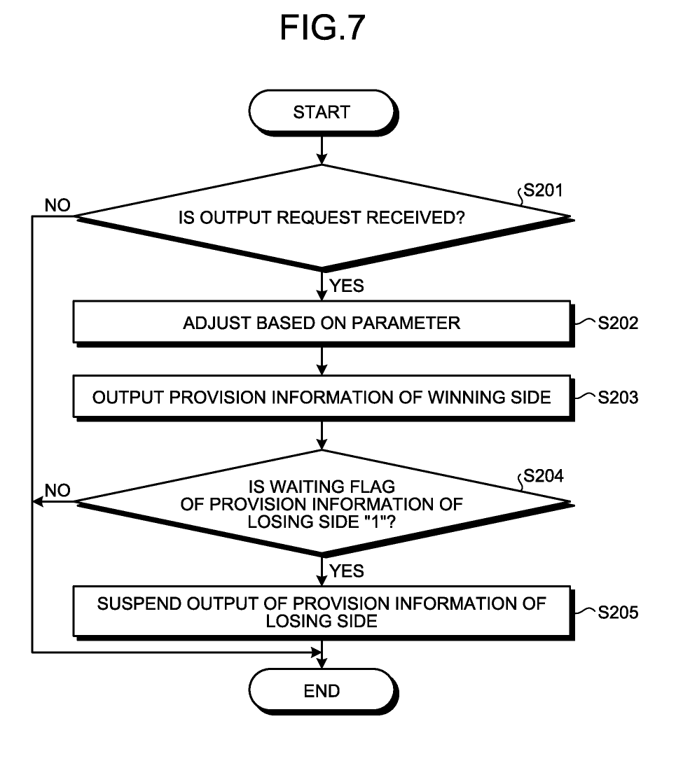

Next, a procedure for an adjusting process to be executed by the output processing apparatus 1 will be explained with reference to FIG. 7. FIG. 7 is a flowchart illustrating the procedure for the adjusting process to be executed by the output processing apparatus 1.

As illustrated in FIG. 7, the reception unit 24 determines whether or not receiving an output request (Step S201). Next, when the reception unit 24 receives the output request (Step S201: Yes), the adjusting unit 25 executes an adjustment on the basis of a parameter indicating a provision priority (Step S202).

As a result of the adjustment, the output processing unit 22 outputs provision information of a winning side (Step S203). As a result of the adjustment, the adjusting unit 25 checks whether or not a waiting flag of provision information of a losing side is “1” (Step S204).

In this case, when the waiting flag is “1” (Step S204: Yes), the adjusting unit 25 suspends an output of the provision information of the losing side (Step S205), and ends the processing.

On the other hand, when the reception unit 24 does not receive an output request (Step S201: No), or when the waiting flag of the provision information of the losing side is “0” (Step S204: No), an output of this provision information is not suspended, and ends the processing.

As described above, the output processing apparatus 1 according to the embodiment includes the acquisition unit 21 and the output processing unit 22. The acquisition unit 21 acquires, from the external apparatus 50, the extended application information 54. The extended application information 54 includes (i) the display component P that is used in operating the extended application 52 included in the external apparatus 50 and (ii) a descriptor that specifies a screen hierarchy of the display component P. The output processing unit 22 displays the display component P in the screen hierarchy specified by the extended application information 54 acquired by the acquisition unit 21.

Therefore, by employing the output processing apparatus 1 according to the embodiment, it is possible to improve the operability of a user without changing a design in accordance with the external apparatus 50.

Meanwhile, in the above-mentioned embodiment, the case has been disclosed in which the output processing apparatus 1 is connected to the “one” external apparatus 50; however, the output processing apparatus 1 may be connected to the plurality of external apparatuses 50. Even in this case, the output processing apparatus 1 is capable of seamlessly displaying the display components P of the extended applications 52 of the plurality of external apparatuses 50.

Moreover, in the above-mentioned embodiment, the output processing apparatus 1 is provided in a vehicle, for example. Thus, there presents an application whose use is limited to during a running period of the vehicle.

Therefore, with respect to the extended application to be limited as described above, the display component P and a descriptor corresponding to the display component P, which are different depending on whether the vehicle is running or stopped, may be previously stored in the extended application information 54.

The output processing apparatus 1 may acquire information that indicates a running state of the vehicle so as to change, in response to the running state, the display component P in accordance with the above-mentioned descriptor. The display component P in running is, for example, an image whose tone is downed so as to cause a user to visually recognize inability to select.

For example, version information indicating an updated version may be stored in the extended application information 54 each time when the external apparatus 50 is updated, and the output processing apparatus 1 may acquire the extended application information 54 having a version to be interpreted by itself.

In this case, it is possible to control the extended application 52 of the external apparatus 50 from the output processing apparatus 1 side regardless of a version of the external apparatus 50.

For example, the extended application information 54 may include a descriptor that specifies a command that is different between a case where a user depresses the display component P or a case where the user has removed from the display component P.

For example, the extended application information 54 may include a descriptor that specifies, when a user depresses the display component P or when the user has removed from the display component P, an image to be next displayed, and this image.

The extended application information 54 may include the plurality of display components P in respective different languages. In this case, the output processing apparatus 1 may display the display component P in a language that is appropriate for that used by the user.

In this case, a design of the output processing apparatus 1 and/or the external apparatus 50 need not be changed depending on a country and an area, so that it is possible to reduce cost of development of the output processing apparatus 1 and the external apparatus 50. Setting of a language to be used may be selected by a user in an initial setting of the output processing apparatus 1, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### REFERENCE SIGNS LIST

1 output processing apparatus
4 touch panel display
21 acquisition unit
22 output processing unit
23 command outputting unit
24 reception unit
25 adjusting unit
26 inner application
50 external apparatus
52 extended application
54 extended application information
P display component

1. An output processing apparatus comprising:
an acquisition unit that acquires, from an external apparatus, extended application information, the extended application information including (i) a display component that is used in operating an extended application included in the external apparatus and (ii) a descriptor that specifies a screen hierarchy of the display component; and
an output processing unit that displays the display component in the screen hierarchy specified by the extended application information acquired by the acquisition unit.

2. The output processing apparatus according to claim 1, wherein
when there presents, in the same screen hierarchy, a plurality of display components including the display component, the output processing unit displays a list of the plurality of display components in the same screen hierarchy.

3. The output processing apparatus according to claim 1, wherein
the extended application information includes a command corresponding to the display component, and
the output processing apparatus is further comprising:
a command outputting unit that is configured to:
when the display component is selected by an operation signal caused by a user's operation, convert the operation signal into a command corresponding to the selected display component; and
output the command to the extended application that is operated by the output command.

4. The output processing apparatus according to claim 3, wherein
when the command outputting unit outputs the command to the extended application, the output processing unit acquires an operation screen corresponding to the command from the extended application, and outputs the acquired operation screen, and
when receiving the operation signal while the output processing unit is outputting the operation screen, the command outputting unit outputs the received operation signal to the extended application.

5. The output processing apparatus according to claim 1, further comprising:
a reception unit that receives, from an application including the extended application, an output request, the output request including (i) provision information to be provided to a user, the provision information including first provision information and second provision information, and (ii) a parameter indicating a priority in providing the provision information; and
an adjusting unit that executes based on the parameter, when the reception unit receives the output request for the second provision information while outputting the first provision information to a user, an adjustment whether to continue outputting the first provision information or to output the second provision information instead of the first provision information.

6. The output processing apparatus according to claim 1, wherein
the extended application information further includes a sound to be output when the display component is selected, and
when the display component is selected, the output processing unit outputs the sound corresponding to the selected display component.

7. An output processing method comprising:
acquiring, from an external apparatus, extended application information, the extended application information including (i) a display component that is used in operating an extended application included in the external apparatus and (ii) a descriptor that specifies a screen hierarchy of the display component; and
displaying the display component in the screen hierarchy specified by the extended application information acquired in the acquiring.
